(19) United States
(12) Patent Application Publication
(10) Pub. No.: US 2010/0040914 A1
(43) Pub. Date: Feb. 18, 2010

(54) FUEL-CASCADED FUEL CELL STACKS WITH DECOUPLED POWER OUTPUTS

(76) Inventors: Sitaram Ramaswamy, West Hartford, CT (US); Margaret M. Steinbugler, East Windsor, CT (US); Leslie L. Van Dine, Manchester, CT (US)

Correspondence Address: M.P.Williams, 210 Main Street, Manchester, CT, 06042, US

(21) Appl. No.: 12/448,666

(22) PCT Filed: Dec. 29, 2006
(86) PCT No.: PCT/US06/49638

§ 371 Date: Jun. 29, 2009

(51) Int. Cl. H01M 8/04

(52) U.S. Cl. 429/14; 429/34

(57) ABSTRACT

Fuel exhaust (109) of a primary fuel cell stack (11) flows into an auxiliary fuel cell stack (12) which powers a DC storage (82) feeding a bi-directional DC/AC converter (86) that is switchable (89) to auxiliary equipment (90, 91) (such as pumps) to a main power bus (54) feeding a main load (55). Fresh fuel (97) is provided (98, 105) to the primary stack for 90% fuel utilization, with over 99% overall power plant fuel utilization. The auxiliary equipment (90, 91) may be powered by the bus (54).

### TECHNICAL FIELD

This disclosure relates to cascaded fuel cell stacks, the second stack receiving the anode effluent of the first stack as its fuel, to achieve about 99% overall fuel utilization with below 70% utilization of fuel through each pass of the first stack. The power output of the two fuel cells are decoupled to achieve different voltages, to be able to serve different loads or the same load, and to require hydrogen starvation protection in only the second fuel cell stack in the cascade, which may be much smaller than the first fuel cell stack.

### BACKGROUND ART

Proton exchange membrane (PEM) fuel cell power plants should achieve close to 99% overall fuel utilization in order to be economical, to reduce fuel discharge to ambient, and to reduce minimum fuel storage requirements, particularly in vehicular applications. If a fuel cell power plant is run near 100% fuel utilization, any increased load transitions requiring more fuel will cause fuel starvation, at least at some portion of some of the fuel cells in the power plant. Such fuel starvation leads to irreversible cell corrosion and concomitant reduction in performance.

One approach to increased fuel utilization while minimizing the risk of starvation, is the use of fuel recycle blowers, ejectors, or combinations thereof which pass fuel from the exit of the fuel cells back to the entrance thereof. While this does achieve higher fuel utilization with low risk of fuel starvation, the recycle blowers are costly, consume power, are unreliable and have freeze tolerance issues. Ejectors usually have limited design ranges of operation, so that a single ejector is unlikely to perform at the full range of fuel utilizations, from idle to full power.

Other proposed approaches for achieving high fuel utilization with little risk of fuel starvation include cascaded stacks of serially connected fuel cells. However, it is difficult to operationally control cascaded stacks in a robust and durable manner, while maintaining high overall utilizations in the presence of transient power demands.

### SUMMARY OF DISCLOSURE

Disclosed features include: PEM fuel cell power plants having high fuel utilization with minimal consequences from resulting fuel starvation; a fuel cell power plant achieving substantially 100% fuel utilization with minimal risk of fuel starvation in a main fuel cell stack that powers a main load; improved efficiency of PEM fuel cell power plants; improved avoidance of fuel starvation in PEM fuel cell power plants; and improved avoidance of the consequences of fuel starvation in high utilization, PEM fuel cell power plants.

This disclosure is predicated on the realization that a primary PEM fuel cell stack feeding a main load need not be the sole consumer of fuel in a productive and efficient way, by consuming the anode exhaust of the primary fuel cell stack in a secondary fuel cell stack which can be of fewer cells, of differently sized cells, and having an isolated voltage output which may differ from that of the main stack.

Accordingly, a primary fuel cell stack for providing power to a main load is associated with an auxiliary fuel cell stack that is not connected in serial voltage relationship with the primary stack, the fuel effluent from the primary fuel cell stack being utilized as a fuel supply by the auxiliary stack; the primary stack can operate at per pass utilizations which are sufficiently low so as to substantially mitigate the risk of fuel starvation in the primary fuel cell stack, while residual fuel from the primary stack is consumed in the auxiliary fuel cell stack, albeit at the risk of fuel starvation, to provide at least about 99% overall fuel efficiency. The power outputs for the two stacks are isolated from each other, thereby permitting the auxiliary stack to serve alternative loads, at alternative voltages.

In one form, the primary stack and the auxiliary stack are not contiguous with each other, having the essential connection only between the fuel exhaust of the primary stack and the fuel inlet of the auxiliary stack. In another form, the stacks are physically cascaded, being disposed contiguously with each other, but of opposite polarity (e.g., ground-to-ground).

The auxiliary stack may have a storage device and storage control, such as a controller operating a bidirectional DC/AC converter, that allows supplying power to assist the primary stack in the event of a fuel shortage, and that allows the primary stack to charge the storage device in the event of excessive fuel compared with the load on the primary stack.

The disclosed method of operating cascaded fuel cell stacks which are electrically isolated from each other includes running the primary stack with a fuel utilization below that which provides little risk of fuel starvation, and operating an auxiliary stack at a utilization sufficient to raise the total utilization of fuel to at least 99%.

Furthermore, the power conditioned output of the auxiliary stack may be adjusted so as to assist the main stack in handling excessively high peak loads.

Other aspects, features and advantages of the present disclosure will become more apparent in the light of the following detailed description of exemplary embodiments thereof, as illustrated in the accompanying drawings.

### BRIEF DESCRIPTION OF THE DRAWINGS

FIG. 1 is a perspective view of a fuel cell power plant having a primary fuel cell stack cascaded with an auxiliary fuel cell stack smaller than a primary fuel cell stack.

FIG. 2 is a simplified, schematic block diagram of a primary fuel cell stack together with an auxiliary fuel cell stack associated with an electric storage augmentation system.

FIG. 3 is a perspective illustration of contiguously cascaded fuel cell stacks.

### MODE(S) FOR CARRYING OUT THE DISCLOSURE

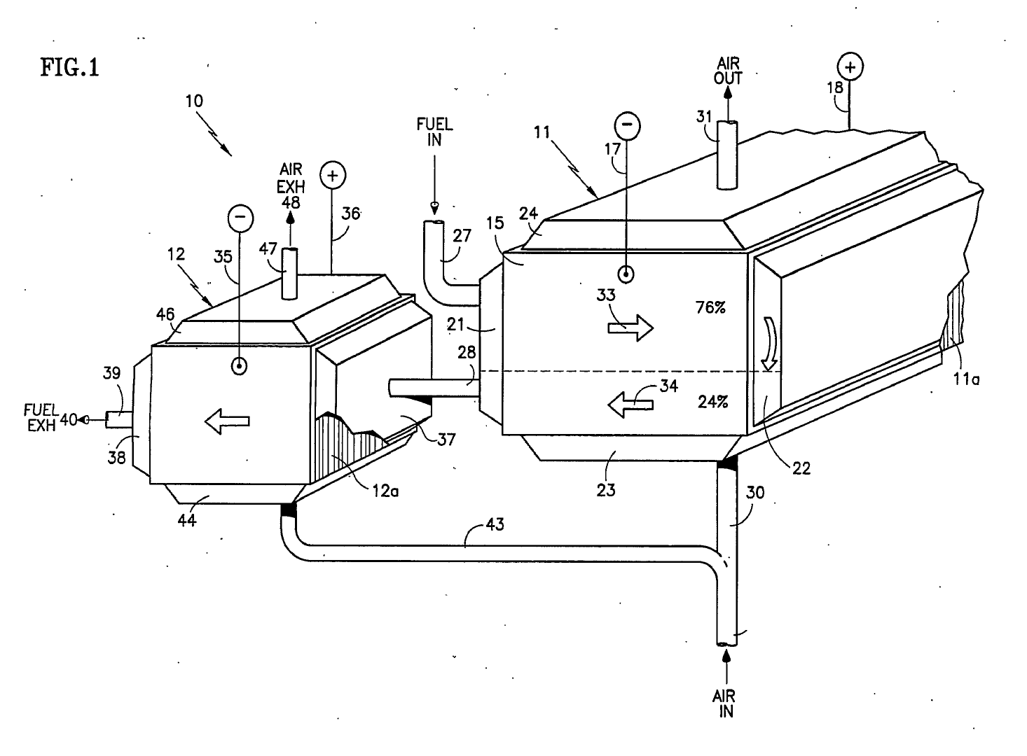

In FIG. 1, a fuel cell power plant 10 includes a primary stack 11 of fuel cells 11a and a secondary stack 12 of fuel cells 12a. The stack 11 has power take-off elements 17, 18 which may be integrated with end plates (not shown). The primary stack has a fuel inlet/outlet manifold 21, a fuel turn manifold 22, an air inlet manifold 23, and an air exit manifold 24. Fuel enters through a fuel inlet conduit 27 and exits through a fuel transfer conduit 28. Air enters through an air inlet conduit 30 and exits through an air exit conduit 31.

As an example only, the fuel reactant gas flow field plates of each of the fuel cells 11a in the stack 11 as well as the fuel inlet/outlet manifold 21 are set up so that 76% of each fuel cell receives fuel in a first pass indicated by an arrow 33, and 24% of each fuel cell receives fuel in a second pass indicated by an arrow 34. In this example, the main stack 11 may comprise, for instance, 32 fuel cells. The output voltage in such a case would range from about 30 volts at minimum load to about 18 volts at maximum rated load.

The auxiliary fuel cell stack 12 has a fuel inlet manifold 37 which receives fuel from the transfer conduit 28, applies it to the fuel cells 12a in the auxiliary stack 12 which has a fuel exit manifold 38; fuel is exhausted through a pipe 39 to exhaust 40. With the primary/auxiliary combination herein, 99% or more of the fuel should be consumed, so that further processing of the fuel exhaust generally should not be necessary; however, further fuel processing may be used in any implementation if desired. The DC output of the auxiliary stack 12 is provided on negative and positive power take-off elements 35, 36.

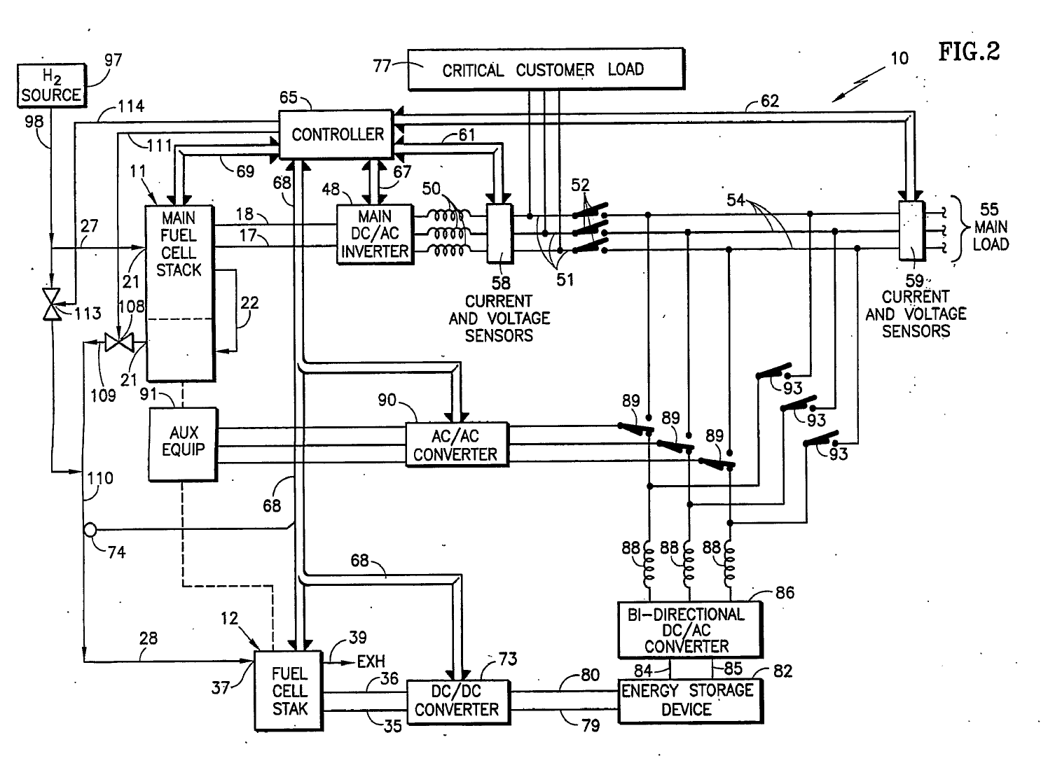

The auxiliary fuel cell stack 12 receives air over a conduit 43, applying it to an air inlet manifold 44, the air then exiting through an air exit manifold 46 and through a conduit 47 to air exhaust 48. Air exhaust of either or both stacks may be applied to further processing, such as enthalpy recovery devices, or otherwise, if desired in any instance. A controller (65, FIG. 2) can regulate air to each stack, independently, by respective conventional valves (not shown) downstream of the exit conduits 31 and 47.

In the example of FIG. 1, by running the primary fuel cell stack 11 with about 69% fuel utilization in each of the passes (33, 34), the overall fuel utilization through the primary stack 11 will be about 90%, an increase of about 10% over the 80% overall utilization typically achieved with a more traditional fuel utilization of about 55% per pass, in a two-pass fuel cell stack.

Concurrently operating a single pass in the auxiliary fuel cell stack 12 at a fuel utilization of about 90%, the overall utilization including both stacks 11, 12 reaches about 99%, while the cells in the main fuel cell stack 11 are operating safely at about 69% or 70% utilization, which provides relatively little risk of both fuel starvation and concomitant performance-decreasing corrosion.

The fuel-cascaded, electrically isolated fuel cell stacks 11, 12 may be utilized in a variety of ways. For instance, the auxiliary stack may be used to power auxiliary equipment such as air and coolant pumps, for either or both stacks. To permit a rapid start after being shut down at temperatures below freezing, it may undergo a boot strap start and thereafter provide power to equipment used to start the primary stack. The auxiliary stack may be utilized with an energy storage device that can support the auxiliary stack loads when hydrogen starvation of the auxiliary stack is occurring, and the storage device can be charged by the auxiliary stack. The storage device can support main loads to avoid fuel starvation in the primary stack. The energy storage device may be used to assist startup and shutdown and to avoid over-voltage in the primary and/or auxiliary fuel cell stacks.

Referring to FIG. 2, the primary fuel cell stack 11 is connected by the positive line 18 and the return line 17 to a power conditioning system which comprises a primary DC/AC inverter 48. The inverter 48 is connected through inductors 50 to three-phase power lines 51 and through a plurality of switches 52 over a three-phase bus 54 to a load 55, which may be a power grid, a vehicle electric motor, or other load. The switches 52 may be either electromechanical or solid state switches.

A plurality of current and voltage sensors 58, 59 determine the current and voltage of each of the three-phase lines 51 and bus 54 and provide signals indicative thereof over respective trunks of lines 61, 62 to a controller 65. In this embodiment, the controller 65 is shown interconnected with trunks of lines 67-69 to the primary DC/AC inverter 48, an optional AC/AC converter 90, a DC/DC converter 73, a hydrogen sensor 74, the auxiliary fuel cell stack 12 and the primary fuel cell stack 11, respectively. However, separate controllers may be used if desired.

The three-phase lines 51 may be connected to a critical customer load 77, if desired. If the main load 55 is a utility power grid, the switches 52 may be closed in some cases when the inverter 48 is shut down, so that power will be supplied to the critical load 77 from the grid (the main load 55).

The auxiliary fuel cell stack 12 is connected through its output lines 35, 36 to the DC/DC converter 73, the output of which on lines 79, 80 are applied to an energy storage device 82. Normally, the energy storage device may be a battery, in which case the voltage on the lines 79, 80 will be in the range of 12-14 volts. On the other hand, if supercapacitors are used as the energy storage device, it may be feasible to omit the DC/DC converter; however, the converter may be utilized for isolation purposes.

The energy storage device 82 is connected by lines 84, 85 to a bidirectional DC/AC converter 86. The output of the converter 86 is applied through a plurality of inductors 88 to respective switches 89 which are connected through an optional AC/AC converter to the fuel cell power plant auxiliary equipment 91. The auxiliary equipment 91 includes at least one pump, such as a reactant (e.g., air) pump or blower or a coolant pump, and may include the power supplies of the controller 64, inverter 48 and converters 73, 82, 90. The auxiliary equipment 91 may include separate pumps for the auxiliary fuel cell stack 12 if separate pumps are used in any case. If the switches 89 are transferred to the upper poles, they will connect the auxiliary equipment 91 to the three-phase bus 54. Another set of switches 93 can be used to selectively connect the converter 86 to the three-phase bus 54.

Hydrogen is provided by a source 97 through conduits 98 and 27 to the fuel manifold 21 of the primary stack 11. The hydrogen exhaust of the primary stack is connected through a valve 108 and conduits 109, 28 to the fuel inlet manifold 37 of the auxiliary stack 12. When the valve 108 is opened in response to a signal on a line 111 from the controller 65, fuel flows through the conduits 98, 27 through the first pass of the fuel flow fields, then through the turnaround manifold 22 and through the remaining pass of the fuel flow fields. The fuel exhaust then flows through the valve 108 and conduits 109, 110, 28 to the fuel inlet 37 of the auxiliary stack 12. Upon start up of the fuel cell power plant, the auxiliary stack may be started first to supply power to the primary stack pumps; the valve 108 will be closed, and a valve 113 will be opened by a controller signal on a line 114, thereby providing fuel from conduit 98 directly to conduits 110, 28 and the auxiliary stack 12.

The controller monitors the load through the sensors 58, 59 and adjusts the valve 108 depending on the load to provide excess fuel to the main stack 12; if the valve provides 1.11 times the stoichiometric requirement for any given load on the stack, the fuel utilization will be about 90%.

In a typical, exemplary situation, the auxiliary fuel cell stack 12 may be started, the energy storage device 82 providing the power through the converters 86 and 90 to the auxiliary equipment 91, to power an air blower and to power a coolant pump. It is possible that a single blower is sufficient to provide air to both the auxiliary stack 12 and the primary stack 11, and that a single coolant pump can provide coolant pressure to both of the stacks 11, 12.

In the typical exemplary case, after the auxiliary fuel cell stack is operational, the primary fuel cell stack may be started, ramping up the power provided to the air blower and the water pump (if only one of each is used), or starting a primary pump or blower, still utilizing the power provided through the energy storage device 82 and the converters 86 and 90. However, the auxiliary fuel cell stack 12 will replenish the energy removed from the storage device 82.

When the primary fuel cell stack is operational, in the event that the hydrogen detector 74 provides an indication to the controller that there is insufficient hydrogen to operate the auxiliary fuel cell stack 12 without likely fuel starvation, the controller will immediately stop the air flow to the auxiliary stack 12, thereby shutting it down in order to avoid cell corrosion, which could permanently damage the cell structures. With the air off, virtually any hydrogen flow will prevent overvoltage or corrosion in the auxiliary stack.

The controller may, either alternatively or additionally, open valve 113 to a degree sufficient to avoid prolonged hydrogen starvation in, and damage to the auxiliary stack 12. The energy storage device 82 will continue to provide power to the auxiliary equipment, or, if it cannot do so because of its state of charge, the switches 89 may be transferred in response to the controller so as to power the auxiliary equipment off the three-phase bus 54. The AC/AC converter 90 may then shift the manner of conversion so as to convert the voltage on the bus 54 to a voltage suitable for the auxiliary equipment.

Another alternative is that the controller 65 can cause the DC/DC converter 73 to drop its load (the storage device 82) whenever the fuel starvation of the auxiliary stack is imminent.

If the auxiliary equipment 91 is designed to operate at the voltage on the three-phase bus 54, the AC/AC converter 90 may be omitted. In that case, the converter 86 normally provides voltage through the inductors 88 that is the same as that on the three-phase bus 54. The switches 93 may be utilized to connect the energy storage device 82 to the three-phase bus 54 in case there is an unusual load or load transient on the three-phase bus 54. When that happens, the primary stack 11 may be consuming more hydrogen than the design amount of hydrogen, thereby starving the auxiliary fuel cell stack 12. In that case, the switches 89 can be transferred to the main bus and the auxiliary stack shut down; or, the valve 113 may be opened. The main bus will, however, receive additional power from the energy storage device 82 through the converter 86 because the switches 93 are closed.

In any case, fuel may be supplied to the auxiliary stack 12, temporarily, through the bypass valve 113, thereby to avoid prolonged fuel starvation and concomitant damage to the auxiliary stack. In such case, the overall fuel utilization may decrease temporarily by a few percentage points.

The main load 55 may be a utility power grid, connected through the switches 52 to the inverter 48. In response to conditions indicated by the current and voltage sensors 58, 59, such as the reduction of several volts for more than a few milliseconds or an abrupt phase change, the controller 65 will immediately stop switching the inverter 48, and disconnect the power bus 54 by opening the switches 52 in a microsecond time frame. Thereafter, the controller will monitor both sides of the switches 52 to determine that the grid 55 is normal again; it will then adjust the phase and voltage magnitude in the inverter to that of the grid 55 prior to reconnecting the inverter to the grid through the switches 52. The inductors 50 absorb differences between the grid and the inverter when they are first interconnected.

Power to the critical customer load 77 may alternatively be maintained with an additional set of switches connecting the inductors 88 to three-phase lines 51, preferably on the side of the current and voltage sensors 58 which is toward the inductors 50, all as is fully described in publication US2005/0184594. On the other hand, if suited in any given implementation, switches may be provided (similar to the switches 93) to connect the inductors 88 directly to the critical customer load whenever the primary fuel cell stack 11 is unable to supply the load. In this context, it should be apparent that the energy storage device 82 may be sized in a manner to allow it to provide a large amount of energy, that which would be used if it were primarily designed as a load support for the primary fuel cell stack 11 so as to assist the primary stack 11 in handling positive and negative flow transients as well as in start-up and shutdown.

In the event that the energy storage device state of charge becomes too low, and it is not able to be adequately charged by the auxiliary fuel cell stack, closure of the switches 93 and transfer of the switches 89 will put the system into an operational condition where the three-phase bus 54 will charge the energy storage device 82 through the bidirectional DC/AC converter 86.

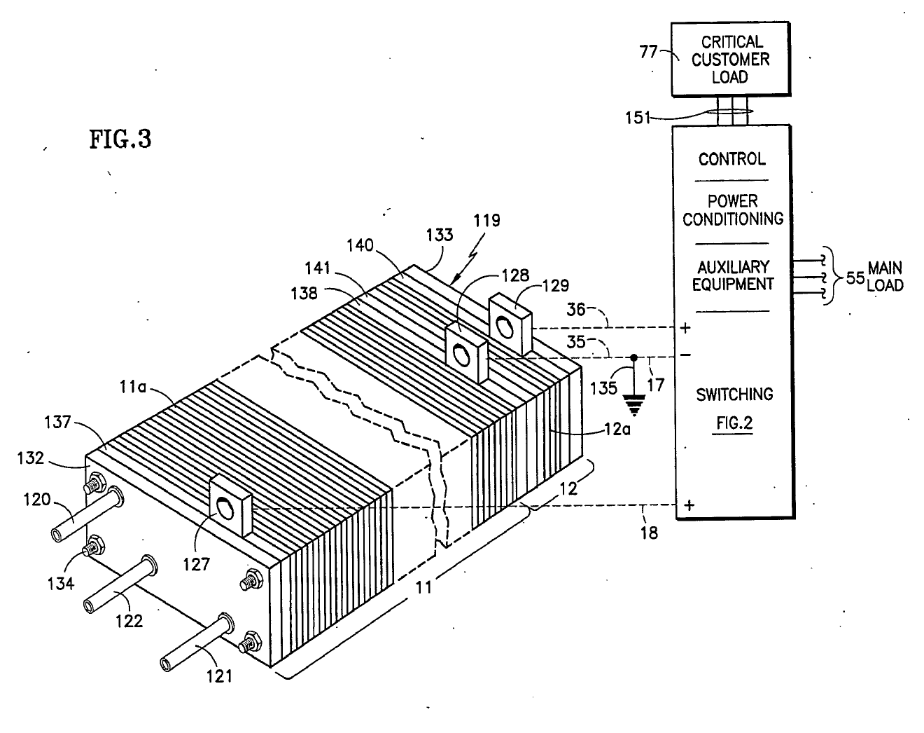

Although shown in FIG. 1 with more than a few fuel cells 12a, the auxiliary stack 12 may typically have only a few cells 12a, such as three or four, as shown in FIG. 3. The auxiliary stack 12 may have fuel cells with a smaller active area than the active area of the fuel cells in the primary stack 11. In either case, the permissible loading of the auxiliary fuel cell stack 12 will be significantly smaller than that of the primary stack 11.

The auxiliary stack 11 may be very inexpensive in contrast with the primary stack. Thus, if the secondary stack 12 is “sacrificed” to protect the primary stack 11 from fuel starvation, the consequences will be less onerous than damage to the primary stack 11 would be.

Other configurations and other modes of operation may be provided. Additional details of power control may be found in patent publications US2005/0106432 and US2005/0184594.

Referring now to FIG. 3, the primary fuel cell stack 11 and auxiliary fuel cell stack 12 are disposed in a contiguous assembly 119 and utilize internal manifolds, typically holes or slots that provide passageways throughout the stacks of cells to conduct the fuel from a fuel inlet pipe 120, air from an air inlet pipe 121 and coolant, such as water, from a coolant inlet pipe 122. The fuel cells 11a of the primary stack 11 and the fuel cells 12a of the auxiliary stack 12 are compressed together, along with power take-off elements 127-129, between end plates 132, 133 (sometimes referred to as “pressure plates”) held together by bolts 134.

The power output of the primary stack 11 is taken from the power take-off elements 127 and 128, and the power output of the auxiliary stack 12 is taken between the power take-off elements 129 and 128. The power take-off element 128 therefore has to represent a common potential, such as is indicated by ground 135. In this arrangement, the anode 137 of the primary stack 11 is adjacent to the power take-off element 127. The cathode 138 of the primary stack is adjacent to the power take-off element 128. On the other hand, the anode 140 of the auxiliary stack 12 is adjacent to the power take-off element 129, whereas the cathode 141 of the auxiliary stack is adjacent to the power take-off element 128. This avoids the necessity of having electrical isolation between the two stacks in this contiguous configuration. The electrical output of the power take-off element 128 represents both of the lines 17 and 35, being the cathode output of both stacks, whereas the electrical output of the power take-off element 129 on the line 36 is the cathode output for the auxiliary stack 12, and the electrical output of the power take-off element 127 on the line 18 is the cathode output of the primary stack 11. These lines 17, 18, 35, 36 are connected in a fashion described hereinbefore with respect to FIG. 2, or in other desired configurations.

1. A method characterized by:
coupling (28, 108-110) fuel exhaust of a primary fuel cell stack (11) to a fuel inlet (37) of an auxiliary fuel cell stack (12) not connected in series voltage relationship with said primary fuel cell stack; and
operating (65) said primary fuel cell stack and said auxiliary fuel cell stack in a manner that avoids fuel starvation in said primary fuel cell stack and that results in substantially all of the fuel provided to said primary fuel cell stack being consumed by said fuel cell stacks without regard to exposing said auxiliary fuel cell stack to fuel starvation.

2. A method according to claim 1 characterized in that said step of operating comprises providing fuel (97, 98, 105, 108) to said primary fuel cell stack to achieve fuel utilization in said primary fuel cell stack of about 90%.

3. A method according to claim 1 characterized in that said step of operating results in about 99% or more of the fuel provided to said primary fuel cell stack being consumed by said fuel cell stacks.

4. A method according to claim 1 further characterized by:
storing electric power (35, 36, 73, 79, 80) generated by said auxiliary fuel cell stack (12) in an energy storage device (82).

5. A method according to claim 4 further characterized by:
providing (86, 89-91) electric power from said energy storage device (82) to operate at least one pump (91) selected from (a) a reactant pump configured to supply a reactant gas to at least one stack selected from said primary fuel cell stack and said auxiliary fuel cell stack, or (b) a coolant pump configured to supply coolant to at least one stack selected from said primary fuel cell stack and said auxiliary fuel cell stack.

6. A method according to claim 4 further characterized by:
selectively (89) providing electric power from either (a) a power bus (54) that provides power from said primary fuel cell stack (11) to a main load (55) or (b) said energy storage device (82), to operate at least one pump selected from (a) a reactant pump configured to supply a reactant gas to at least one stack selected from said primary fuel cell stack and said auxiliary fuel cell stack, and (b) a coolant pump configured to supply coolant to at least one stack selected from said primary fuel cell stack and said auxiliary fuel cell stack.

7. A method according to claim 4 further characterized by:
selectively conducting (77, 86, 89) power either (a) from said energy storage device (82) to a power bus (54) that provides power from said primary fuel cell stack (11) to a main load (55) of said power plant, or (b) to said energy storage device from said power bus.

8. A method according to claim 4 further characterized by:
said steps of operating and storing comprise storing electric power (35, 36, 73, 79, 80) generated by said auxiliary fuel cell stack (12) in said energy storage device (82) and ceasing to store electric power generated by said auxiliary fuel cell stack in immediate response to the amount of fuel being provided from said primary fuel cell stack to said secondary fuel cell stack being sufficiently low so as to render fuel starvation in said secondary stack likely to occur.

9. A method according to claim 1 further characterized by:
providing (77, 97, 98, 110, 113) fresh fuel to said auxiliary fuel cell stack (12) prior to start-up of said primary fuel cell stack (11).

10. A method according to claim 1 further characterized by:
providing (77, 97, 98, 110, 113) fresh fuel to said auxiliary fuel cell stack (12) after start up of said primary fuel cell stack (11) to avoid fuel starvation in said auxiliary fuel cell stack.

11. A method according to claim 1 further characterized by:
providing (77, 97, 98, 110, 113) fresh fuel to said auxiliary fuel cell stack (12) during normal operation of said primary fuel cell stack (11) to avoid fuel starvation in said auxiliary fuel cell stack.

12. A method according to claim 1 further characterized in that said step of operating includes providing more than stoichiometric amount of air to each of said stacks (11, 12) and ceasing to provide air to said auxiliary stack in immediate response to the amount of fuel being provided from said primary fuel cell stack to said secondary fuel cell stack being sufficiently low so as to render fuel starvation in said secondary stack likely to occur.

13. A method according to claim 1 further characterized by:
said step of operating said fuel cell stacks includes electrically loading said primary fuel cell stack independently of electrically loading said auxiliary fuel cell stack.

14. A method according to claim 1 characterized in that said step of operating comprises operating said primary fuel cell stack (11) and said secondary fuel cell stack (12) in a manner that sacrifices said secondary fuel cell stack to the effects of fuel starvation in order to protect said primary fuel cell stack from degradation.

15. A fuel cell power plant (10) comprising:
a primary fuel cell stack (11);
characterized by:
an auxiliary fuel cell stack (12) not connected in serial voltage relationship with said primary fuel cell stack;
means (28, 108-110) configured to couple fuel exhaust of said primary fuel cell stack to a fuel inlet of said secondary fuel cell stack; and
means (65) configured to operate said primary fuel cell stack and said auxiliary fuel cell stack in a manner that avoids fuel starvation in said primary fuel cell stack and that results in substantially all of the fuel provided to said primary fuel cell stack being consumed by said fuel cell stacks without regard to exposing said auxiliary fuel cell stack to fuel starvation.

16. A power plant (10) according to claim 15 further characterized by:
an electric energy storage device (82); and
means (35, 36, 73, 79, 80) configured to store electric power generated by said auxiliary fuel cell stack (12) in said electric energy storage device.

17. A power plant (10) according to claim 16 further characterized by:
means (86, 89-91) configured to provide electric power from said energy storage device (82) to operate at least one pump (91) selected from (a) a reactant pump configured to supply a reactant gas to at least one stack selected from said primary fuel cell stack (11) and said auxiliary fuel cell stack (12), or (b) a coolant pump configured to supply coolant to a stack selected from said primary fuel cell stack and said auxiliary fuel cell stack.

18. A power plant (10) according to claim 16 further characterized by:
means (89) configured to selectively provide electric power from either (a) a power bus (54) that provides power from said primary fuel cell stack (11) to a main load (55) of said power plant or (b) said energy storage device (82), to operate at least one pump (91) selected from (a) a reactant pump configured to supply a reactant gas to a stack selected from said primary fuel cell stack and said auxiliary fuel cell stack, or (b) a coolant pump configured to supply coolant to a stack selected from said primary fuel cell stack and said auxiliary fuel cell stack.

19. A power plant (10) according to claim 16 further characterized by:
means (86, 89) configured to selectively conduct power either (a) from said electric storage device (82) to a power bus (54) that provides power from said primary fuel cell stack (11) to a main load (55) of said power plant, or (b) from said power bus to said electric storage device.

20. A power plant (10) according to claim 15 further characterized by:
means (77, 97, 98, 110, 113) configured to provide fresh fuel to said auxiliary fuel cell stack (12) prior to start-up of said primary fuel cell stack (11).

21. A power plant (10) according to claim 15 further characterized by:
means (77, 97, 98, 110, 113) configured to provide fresh fuel to said auxiliary stack after start up of said primary fuel cell stack (12) to avoid fuel starvation in said auxiliary fuel cell stack (11).

22. A power plant (10) according to claim 15 further characterized by:
means (77, 97, 98, 110, 113) configured to provide fresh fuel to said auxiliary stack during normal operation of said primary fuel cell stack (12) to avoid fuel starvation in said auxiliary fuel cell stack (11).

23. A power plant (10) according to claim 15 further characterized by:
said auxiliary fuel cell stack (12) having less power output capability than said primary fuel cell stack (11).

24. A power plant (10) according to claim 15 further characterized by:
said auxiliary fuel cell stack (12) having a different number of fuel cells (11a) than the number of fuel cells (11a) in said primary fuel cell stack (11).

25. A power plant (10) according to claim 24 further characterized by:
said auxiliary fuel cell stack (12) having a fewer number of fuel cells (11a) than the number of fuel cells (11a) in said primary fuel cell stack (11).

26. A power plant (10) according to claim 15 further characterized by:
the fuel cells (11a) in said primary fuel cell stack (11) have active areas different than the active areas of the fuel cells (12a) in said secondary fuel cell stack (12).

27. A power plant (10) according to claim 26 further characterized by:
the fuel cells (11a) in said primary fuel cell stack (11) have active areas larger than the active areas of the fuel cells (12a) in said secondary fuel cell stack (12).

28. A power plant (10) according to claim 15 further characterized by:
said fuel cell stacks (11, 12) being configured in a single contiguous structure.

29. A power plant (10) according to claim 28 further characterized by:
said fuel cell stacks (11, 12) being configured with either (a) a cathode end of the primary stack (11) contiguous with a cathode end of the secondary stack, or (b) an anode end of the primary stack contiguous with the an anode end of the secondary stack.

30. A power plant (10) according to claim 15 characterized in that said means (65) configured to operate said primary fuel cell stack (11) and said secondary fuel cell stack (12) operates said fuel cell stacks in a manner that sacrifices said secondary fuel cell stack to the effects of fuel starvation in order to protect said primary fuel cell stack from degradation.
